(19) United States
(12) Patent Application Publication
(10) Pub. No.: US 2018/0158572 A1
(43) Pub. Date: Jun. 7, 2018

(54) HEAVY-CURRENT CABLE AND POWER SUPPLY SYSTEM WITH A HEAVY-CURRENT CABLE

(71) Applicant: LEONI KABEL GMBH, Nuernberg (DE)

(72) Inventors: Christian Ernst, Weissenburg (DE); Sebastian Goss, Roth (DE); Bastian Hitz, Postbauer-Heng (DE)

(21) Appl. No.: 15/831,671

(22) Filed: Dec. 5, 2017

(30) Foreign Application Priority Data
Dec. 5, 2016 (DE) 10 2016 224 106.0

(51) Int. Cl. H01B 7/42; H01B 7/04; H01B 9/00; H01B 13/14

(52) U.S. Cl. CPC H01B 7/428; H01B 7/041; H01B 13/14; H01B 9/003; H01B 7/423

(57) ABSTRACT

A heavy-current cable, in particular a charging cable, has an outer jacket, a number of heavy-current cores which extend in the longitudinal direction, and at least one cooling jacket with at least one hollow chamber extending in the longitudinal direction for conducting a coolant. A power supply system, in particular a charging system for a hybrid or electric vehicle, has such a corresponding heavy-current cable.

### CROSS-REFERENCE TO RELATED APPLICATION

This application claims the benefit, under 35 U.S.C. § 119, of German patent application DE 10 2016 224 106.0, filed Dec. 5, 2016; the prior application is herewith incorporated by reference in its entirety.

### BACKGROUND OF THE INVENTION

### Field of the Invention

The invention relates to a heavy-current cable, in particular to a charging cable, with an outer jacket and with a number of heavy-current cores which extend in the longitudinal direction, and to a power supply system, in particular to a charging system for a hybrid or electric vehicle, with a corresponding heavy-current cable.

Cables that are configured for conducting relatively high currents and therefore for transmitting relatively high electrical powers are called heavy-current cables. In this case, a relatively large amount of waste heat is typically generated by conducting correspondingly high currents, a corresponding heavy-current cable being relatively considerably heated by the waste heat during operation.

However, this is potentially problematic in a variety of application scenarios since a heavy-current cable of this kind cannot be readily arranged and installed in the vicinity of temperature-sensitive components and assemblies for example. Application scenarios in which it can be assumed or in which there is a considerable risk that persons will come into contact with a heavy-current cable which is used are likewise problematic since, in this case, it is necessary to ensure that a corresponding heavy-current cable is not heated to such an extent that there is a risk of injury during operation.

A typical example of this are so-called charging cables for electric vehicles through which relatively high currents are conducted during a charging process and which at the same time have to be configured in such a way that contact can be made with the charging cables without problems over a relatively long period of time.

### SUMMARY OF THE INVENTION

Proceeding from the above, the object of the invention is to specify a heavy-current cable of advantageous configuration and a power supply system of advantageous design and with a corresponding heavy-current cable.

According to the invention, this object is achieved by a heavy-current cable having the features of the main cable claim, and by a power supply system having the features of the main system claim. Preferred developments are contained in the dependent claims. The advantages and preferred refinements cited in respect of heavy-current cables can be transferred by analogy to the power supply system as well, and vice versa.

In this case, a corresponding heavy-current cable is configured, in particular, as a charging cable, for example as a charging cable for a hybrid or electric vehicle, or as a robotic line, for example for a welding robot, and has a number of heavy-current cores which extend in a longitudinal direction, and an outer jacket. Here, each heavy-current core in turn has a conductor, for example a braided conductor or a solid conductor, and a core insulation which surrounds the conductor and is extruded, in particular, onto the conductor. In addition, the heavy-current cable has an, in particular extruded, cooling jacket with at least one hollow chamber, which extends in the longitudinal direction, for conducting a coolant, so that the heavy-current cable can be cooled by a coolant being conducted or carried through the heavy-current cable.

In this way, a kind of heat exchanger for a cooling circuit is then integrated into the heavy-current cable as it were, this being formed by the cooling jacket. As a result, it is then possible, for example at a maximum surface temperature of, for example, 60° C. which is prespecified for the heavy-current cable, to conduct higher currents through the heavy-current cable than would be the case for a heavy-current cable which has not been cooled or cooled only passively by the ambient air.

In this case, the cooling jacket is preferably an annular, integral jacket which is extruded on and in which the at least one hollow chamber is integrated. The cooling jacket is therefore formed in a simple manner in respect of process engineering by a jacket extrusion operation in which the cooling jacket is extruded onto a core element.

According to one design variant, the cooling jacket forms, here, the outer jacket of the heavy-current cable and therefore, in particular, an insulating jacket which closes off the heavy-current cable to the outside. However, a design variant in which the cooling jacket is part of a heavy-current core or in which each heavy-current core of the heavy-current cable has a cooling jacket is preferred.

In one advantageous development, each heavy-current core further has an, in particular, integral cooling jacket which is preferably extruded on and has a kind of inner ring, which cooling jacket forms the core insulation of the heavy-current core and surrounds or envelopes the conductor of the heavy-current core directly as conductor insulation. As an alternative to this, the conductor of a heavy-current core is surrounded by a separate core insulation onto which the cooling jacket is extruded.

A heavy-current cable presented here is further expediently configured for currents of greater than 5 A, preferably of greater than 10 A, further preferably of greater than 50 A and in particular of greater than 100 A. In addition, the heavy-current cable is preferably configured for currents of less than 1,000 A and in particular less than 500 A. A corresponding heavy-current cable is therefore preferably configured for a current intensity which lies in the range of between 10 A and 1,000 A, and in particular in the range of between 100 A and 500 A. According to one advantageous design variant, a heavy-current cable of this kind is additionally configured for direct currents, that is to say in particular as a charging cable for DC charging. Corresponding DC charging is then performed, for example, at 1,000 V and 450 A.

A refinement of the heavy-current cable in which it has a core element which is arranged centrally and extends in the longitudinal direction and around which a plurality of heavy-current cores are arranged is additionally advantageous. In this case, that core element is formed, for example, by a further heavy-current core, a protective conductor with or without insulation, a hose or a supporting element.

Furthermore, a refinement of the heavy-current cable in which the heavy-current cable has a protective conductor, which is arranged centrally and extends in the longitudinal direction, and has a plurality of heavy-current cores which are arranged around the protective conductor is expedient. Those heavy-current cores are then further preferably indirectly or directly enveloped by the outer jacket, possibly with the interposition of a shield and/or a number of filling elements. Here, each heavy-current core advantageously has a cooling jacket with a plurality of hollow chambers which are separated from one another and each extend in the longitudinal direction and, depending on the intended application, each have a round, oval or rectangular cross section or a cross section which is designed in the manner of a segment of a ring.

According to an alternative design variant, the heavy-current cable has a hose, which is arranged centrally and extends in the longitudinal direction, for conducting a coolant and has a plurality of heavy-current cores which are arranged around the hose. In this case too, the heavy-current cores are further preferably enveloped by the outer jacket, possibly with the interposition of a shield and/or a number of fillers, and, in addition, each heavy-current core preferably has a cooling jacket with exactly one hollow chamber which extends in the longitudinal direction. The cross section of the corresponding hollow chambers is matched to the respective intended application and is, for example, of round configuration in this case too.

According to one refinement variant, the heavy-current cable is further configured as so-called piece goods and is accordingly manufactured as part of a further processing operation and, in the process, is split into segments of different length for example. As an alternative to this, the heavy-current cable is at least partially prefabricated and has, at at least one end, a connection element with a coolant connection, wherein the coolant connection is connected to the at least one hollow chamber which extends in the longitudinal direction, and wherein the connection element is configured for connection to a coolant line, in particular of a cooling circuit. Here, that connection element is further preferably additionally configured as a cable connection element with electrical connection contacts, that is to say, for example, in the manner of a conventional plug in which, however, at least one coolant connection is additionally integrated, so that a coolant can be conducted into or carried out of the at least one hollow chamber by means of the coolant connection.

According to one advantageous development, the corresponding connection element has two coolant connections, which are separated from one another, for a feed line and for a return line. The two coolant connections are preferably connected to different hollow chambers which extend in the longitudinal direction. In this case, at least one hollow chamber can then be used for the feed line and a further hollow chamber can be used for the return line in a coolant circuit.

An above-described heavy-current cable is preferably also configured, as already explained above, as a charging cable, in particular as a charging cable for a hybrid or electric vehicle, and has at least one charging plug which is arranged at the end and has a number of electrical contacts, typically one electrical contact for each core and for each protective conductor. Here, that charging plug is configured, in particular, in accordance with the standard IEC 62196-2 (or SAE J1772-2009) or in accordance with the standard EN 62196. In this case, at least one coolant connection by which a coolant can be carried into or out of the charging cable is additionally preferably integrated into a charging plug of this kind.

An above-described heavy-current cable is further preferably part of a power supply system, in particular of a charging system for a hybrid or electric vehicle, and is accordingly a component of the power supply system which is matched to the power supply system. In this case, a power supply system of this kind typically has an electrical energy source, for example a so-called charging station, an electrical energy sink, such as an electrical consumer or a rechargeable battery for example, and a cooling circuit for actively cooling the heavy-current cable. The electrical energy source is then connected to the electrical energy sink by the heavy-current cable for transmitting electrical energy during operation of the power supply system, wherein the heavy-current cable is cooled with the aid of the cooling circuit during the operation. In this case, the at least one cooling jacket in the heavy-current cable serves as an integrated heat exchanger in the cooling circuit, with the aid of which heat is transmitted from the heavy-current cable into the coolant of the cooling circuit.

Here, a refinement in which the heavy-current cable has a plurality of hollow chambers and in which at least one hollow chamber serves as a feed line and at least one hollow chamber serves as a return line in the coolant circuit is preferred in particular, so that the coolant is carried via the hollow chamber, which forms the feed line, through the heavy-current cable over its entire length and a further time via the hollow chamber, which forms the return line, through the heavy-current cable over its entire length. That is to say, therefore, that in this case the coolant is carried through the heavy-current cable twice over virtually the full length of the heavy-current cable on its way through the cooling circuit.

An above-described charging cable is therefore, in particular, part of a charging system for a hybrid or electric vehicle and has a charging plug at one end. The other, second end of the charging cable is then further preferably fixedly installed, that is to say, for example, fixedly installed or incorporated in a charging column or charging station. A charging system of this kind then expediently has an active cooling system and substantially consists of a charging station with the charging cable and at least one hybrid or electric vehicle with a rechargeable battery and with a socket or a mating plug for the charging plug. Depending on the application scenario, either only the charging cable is cooled or else further components in the charging system are also cooled, for example the current-carrying lines in the hybrid or electric vehicle from the socket or the mating plug to the rechargeable battery and/or the rechargeable battery itself, during operation in a charging system of this kind. In this case, the essential components of the corresponding cooling system or cooling circuit are preferably arranged and installed in the charging column or charging station or else in the hybrid or electric vehicle, depending on the design. As an alternative, a corresponding charging system has more than one cooling circuit, that is to say, for example, one cooling circuit in the charging column or charging station for cooling the current-carrying assemblies as far as the charging plug, and one cooling circuit in the hybrid or electric vehicle for cooling the current-carrying lines in the hybrid or electric vehicle from the socket or the mating plug to the rechargeable battery and/or for cooling the rechargeable battery.

Other features which are considered as characteristic for the invention are set forth in the appended claims.

Although the invention is illustrated and described herein as embodied in a heavy-current cable and a power supply system with a heavy-current cable, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, cross-sectional illustration through a first embodiment of a heavy-current cable according to the invention;

FIG. 2 is a cross-sectional illustration through a second embodiment of the heavy-current cable;

FIG. 3 is a side view of a third embodiment of the heavy-current cable with a connection element; and

FIG. 4 is a block diagram illustration of a charging system with the heavy-current cable.

### DETAILED DESCRIPTION OF THE INVENTION

Parts which correspond to one another are respectively provided with the same reference symbols throughout the figures.

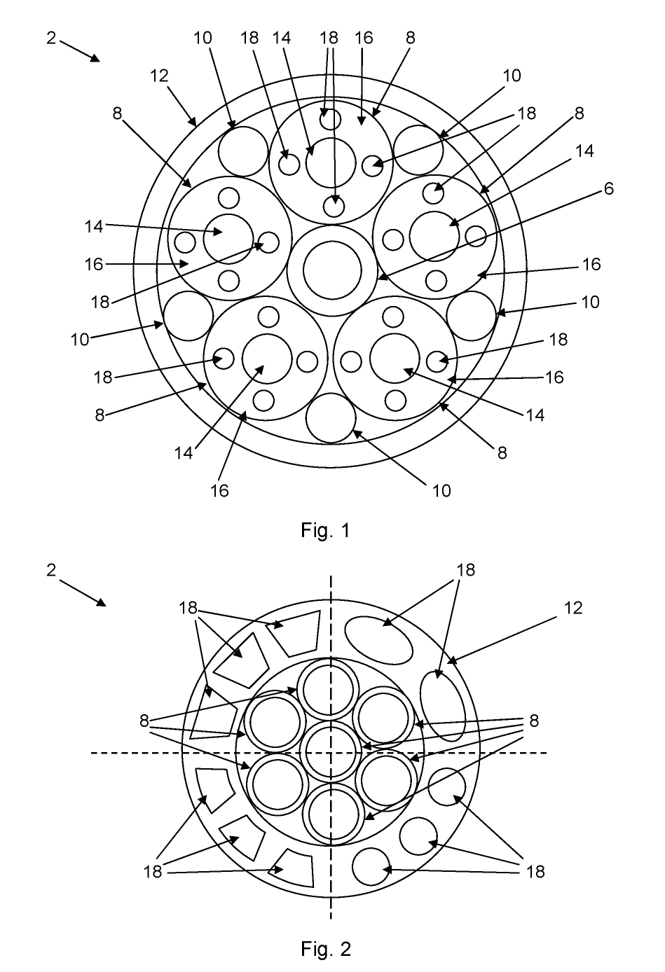

Referring now to the figures of the drawings in detail and first, particularly to FIG. 1 thereof, there is shown a heavy-current cable 2 which is described by way of example below and is designed, in particular, as a charging cable for a hybrid or electric vehicle and is accordingly designed for relatively high currents, typically of greater than 100 A but generally less than 500 A.

In this case, that heavy-current cable 2 has a core element which is arranged centrally, extends in a longitudinal direction 4 and is formed by an insulated protective conductor 6. In the exemplary embodiment, five heavy-current cores 8 are arranged around that protective conductor 6, wherein the heavy-current cores 8 firstly bear against the protective conductor 6 and secondly against one another. An outer jacket 12, which closes off the heavy-current cable 2 to the outside, is extruded onto this arrangement of heavy-current cores 8, with the interposition of five filling elements or fillers 10. Here, the fillers 10 are configured as profile strips which extend in the longitudinal direction 4 and serve to implement as round as possible a circumference for the heavy-current cable 2.

In the exemplary embodiment, each heavy-current core 8 is formed by a conductor 14 and a cooling jacket 16 which is extruded onto the conductor 14. Here, a corresponding cooling jacket 16 has four hollow chambers 18 which extend in the longitudinal direction 4 and through which a coolant can be conducted. As a result, each cooling jacket 16 forms, as it were, a heat exchanger which can be incorporated into a cooling circuit 20. At the same time, the cooling jacket 16 serves as an insulating jacket for the corresponding conductor 14 in the exemplary embodiment, wherein the cooling jacket 16 has, for this purpose, an annular inner section, that is to say a kind of inner ring, which completely envelops the corresponding conductor 14 and, like the entire integral cooling jacket 16, is produced from an insulating material.

An alternative refinement of the heavy-current cable 2 is illustrated in cross section in FIG. 2, wherein the heavy-current core 8 is arranged centrally as core element and extends in the longitudinal direction 4 here. In the exemplary embodiment according to FIG. 2, six further heavy-current cores 8 are arranged around first the heavy-current core 8, the further heavy-current cores in turn being enveloped by an outer jacket 12 which closes off the heavy-current cable 2 to the outside. Here, the outer jacket 12 is formed by a cooling jacket 16 which has a plurality of hollow chambers 18 which are arranged in a manner distributed over the circumference. In this case, the hollow chambers 18 have an oval, a round or a trapezoidal cross section or a cross section in the form of a segment of a ring, depending on the application and profile of requirements. These four different variants are shown in the four quadrants of the cross-sectional illustration in FIG. 2.

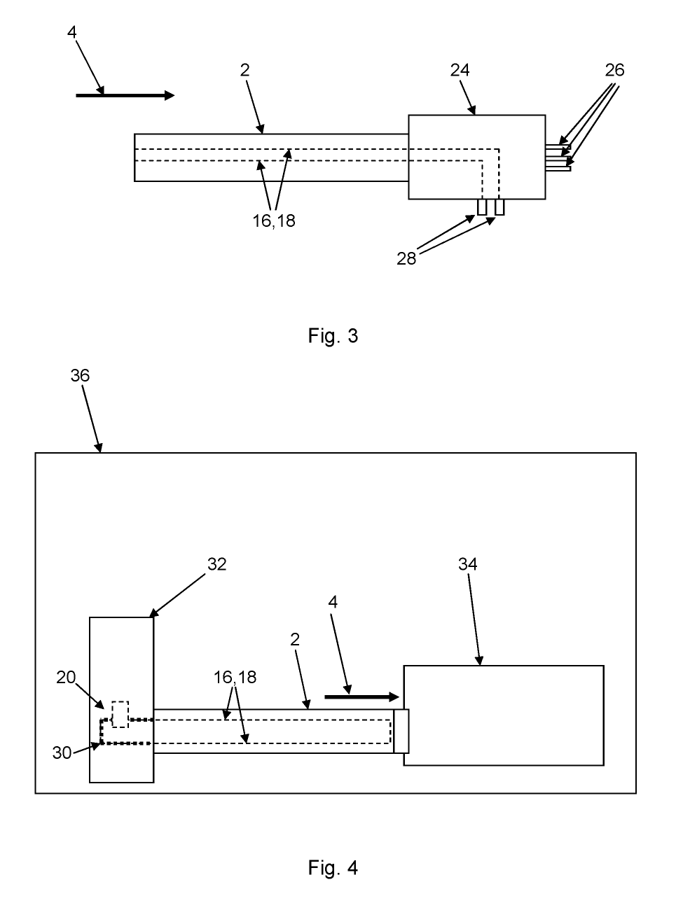

Irrespective of these refinement features, a corresponding heavy-current cable 2 further preferably has a connection element 24 at at least one end and is accordingly at least partially prefabricated. A connection element 24 of this kind is, as indicated in FIG. 3, preferably designed in the manner of a plug and accordingly has a number of electrical contacts 26. However, furthermore, the connection element 24 further has two coolant connections 28 by means of which a coolant can be introduced into and/or carried out of the hollow chambers 18 of the heavy-current cable 2.

In this case, those coolant connections 28 are configured for connection to a coolant line 30, so that the heavy-current cable 2 can be connected to a cooling circuit 20 in a simple manner. A corresponding situation is outlined in FIG. 4. Here, a charging station 32, an electric vehicle 34, the heavy-current cable 2 and the cooling circuit 20 form a charging system 36. In the charging system, the heavy-current cable 2 is connected to the electric vehicle 34, for example by means of a plug-in connection, that is to say a plug, for a charging process. Subsequently, electrical power is transmitted from the charging station 32, by means of the heavy-current cores 8 of the heavy-current cable 2, to the electric vehicle 34.

During this power transmission operation, the heavy-current cores 8 of the heavy-current cable 2 are further cooled with the aid of the cooling circuit 20 of the charging station 32, wherein a coolant is driven through the heavy-current cable 2 for this purpose. Here, the corresponding coolant is driven through the hollow chambers 18 which are present in the heavy-current cable 2, so that each cooling jacket 16 acts as a heat exchanger in the cooling circuit 20, heat being transmitted from the conductors 14 into the coolant by said heat exchanger. In the exemplary embodiment, both a feed line and a return line are realized for the cooling circuit 20 in the heavy-current cable 2 and accordingly the coolant is driven through the heavy-current cable 2 twice over virtually the full length of the heavy-current cable 2 on its way through the coolant circuit 20.

If the heavy-current cable 2 is configured, for example, in accordance with FIG. 1 here, each cooling jacket 16 is preferably incorporated into the cooling circuit 20 in such a way that at least one hollow chamber 18 of a cooling jacket 16 is used as a feed line and at least one hollow chamber 18 of the corresponding cooling jacket 16 is used as a return line.

The invention is not restricted to the exemplary embodiment described above. Rather, other variants of the invention can also be derived from the exemplary embodiment by a person skilled in the art, without departing from the subject matter of the invention. In particular, all individual features described in connection with the exemplary embodiment can further also be combined with one another in a different way, without departing from the subject matter of the invention.

1. A heavy-current cable, comprising:
a plurality of heavy-current cores extending in a longitudinal direction, each of said heavy-current cores having a conductor and a core insulation surrounding said conductor;
an outer jacket; and
at least one cooling jacket having at least one hollow chamber extending in the longitudinal direction for conducting a coolant.

2. The heavy-current cable according to claim 1, wherein said cooling jacket with said hollow chambers is configured as an extruded annular jacket.

3. The heavy-current cable according to claim 1, wherein:
said cooling jacket is one of a plurality of cooling jackets; and
each of said heavy-current cores has said one of said cooling jackets.

4. The heavy-current cable according to claim 3, wherein each of said cooling jackets has an inner ring, and said cooling jacket forms said core insulation of said heavy-current cores and surrounds said conductor of said heavy-current cores directly as a conductor insulation.

5. The heavy-current cable according to claim 1, wherein the heavy-current cable is configured for currents of greater than 10 A.

6. The heavy-current cable according to claim 1, further comprising a core element disposed centrally and extending in the longitudinal direction, and said plurality of heavy-current cores are disposed around said core element.

7. The heavy-current cable according to claim 1,
further comprising a protective conductor being disposed centrally and extending in the longitudinal direction and said plurality of heavy-current cores are disposed around said protective conductor; and
wherein said cooling jacket is one of a plurality of cooling jackets having a plurality of hollow chambers, each of said heavy-current cores has one of said cooling jackets with said plurality of hollow chambers which are separate from one another and each extend in the longitudinal direction.

8. The heavy-current cable according to claim 1,
further comprising a hose disposed centrally and extending in the longitudinal direction, for conducting the coolant and said plurality of heavy-current cores are disposed around said hose; and
wherein said cooling jacket is one of a plurality of cooling jackets, each of said heavy-current cores has one of said cooling jacket with exactly one said hollow chamber extending in the longitudinal direction.

9. The heavy-current cable according to claim 1, further comprising a connection element with a coolant connection being disposed at at least one end of the heavy-current cable, said coolant connection is connected to said at least one hollow chamber which extends in the longitudinal direction, said connection element is configured for connection to a coolant line, and said connection element is configured as a cable connection element with electrical connection contacts.

10. The heavy-current cable according to claim 9, wherein:
said hollow chamber is one of a plurality of hollow chambers; and
said connection element has two coolant connections for a feed line and a return line, and said two coolant connections are connected to different ones of said hollow chambers which extend in the longitudinal direction.

11. The heavy-current cable according to claim 1, wherein the heavy-current cable is configured as a charging cable for a hybrid or electric vehicle having at least one charging plug which is disposed at an end of said heavy-current cable, said charging plug has electrical contacts and at least one coolant connection.

12. The heavy-current cable according to claim 1, wherein the heavy-current cable is configured for currents of greater than 100 A.

13. The heavy-current cable according to claim 1, wherein the heavy-current cable is a charging cable.

14. A power supply system, comprising:
a heavy-current cable, containing:
a plurality of heavy-current cores extending in a longitudinal direction, each of said heavy-current cores having a conductor and a core insulation surrounding said conductor;
an outer jacket; and
at least one cooling jacket having at least one hollow chamber extending in the longitudinal direction for conducting a coolant;
an electrical energy source;
an electrical energy sink;
a cooling circuit for actively cooling said heavy-current cable; and
said electrical energy source and said electrical energy sink are connected to one another by means of said heavy-current cable for transmitting electrical energy during operation, and said at least one cooling jacket also forms said cooling circuit during operation.

15. The power supply system according to claim 14, wherein:
said at least one hollow chamber includes a first hollow chamber and a second hollow chamber; and
said cooling circuit is configured in such a way that, during the operation, the coolant which is carried therein is carried through said first hollow chamber, which extends in the longitudinal direction and forms a feed line, through said heavy-current cable over an entire length, and that the coolant is returned through said second hollow chamber, which extends in the longitudinal direction and forms a return line, through said heavy-current cable over the entire length.

16. The power supply system according to claim 14, wherein the power supply system is a charging system for a hybrid or electric vehicle.
